(19) United States
(12) Patent Application Publication
(10) Pub. No.: US 2021/0367458 A1
(43) Pub. Date: Nov. 25, 2021

(54) GEARED MOTOR WITH DOUBLE DIAMETER STATOR

(71) Applicant: BONTAZ CENTRE R & D, Mamaz (FR)

(72) Inventors: Anthony TAUPEAU, Saint-Jorioz (FR); Nicolas BONNEVAY, Annecy (FR); Thibaut PEULMEULE, Annecy (US)

(21) Appl. No.: 17/323,219

(22) Filed: May 18, 2021

(30) Foreign Application Priority Data
May 19, 2020 (FR) 2005053

(51) Int. Cl. H02K 1/14; F16K 31/04; F16H 57/02; H02K 7/116

(52) U.S. Cl. CPC H02K 1/141; F16K 31/043; F16H 57/02; F16H 1/46; H02K 2201/03; F16H 2057/02034; H02K 7/116

(57) ABSTRACT

Geared motor including a brushless electric motor, a planetary reduction gear and an output shaft with a longitudinal axis, fixed in rotation to the planetary reduction gear, the electric motor including a stator, a rotor housed in a housing in the stator and surrounded by a lateral surface of the housing, at least two coils attached to the stator and facing a portion of an outer lateral surface of the rotor. The stator and the rotor define at least one first zone with a first air gap and one second zone with a second air gap between them, the first air gap being less than the second air gap, the first zone including the coils, such that the attraction force exerted by the stator on the rotor is lower in the second zone than in the first zone.

### CROSS-REFERENCE TO RELATED APPLICATIONS

This application claims priority to French Patent Application No. 2005053 filed on May 19, 2020, the entire content of which is incorporated by reference herein.

### TECHNICAL FIELD AND STATE OF PRIOR ART

This invention relates to a geared motor comprising a brushless motor and a reduction gear, the stator of which has a double diameter, the geared motor thus being more reliable. Valves controlled by a geared motor in open-or-closed or proportionally are used in the automotive industry. For example, these valves are used to manage the supply of coolant, fuel, oil, etc.

The geared motor may comprise a rotor with magnets, housed in a stator comprising coils. The reduction gear is housed in the rotor. The output shaft is coaxial with the rotor. One example of such a geared motor is described in document WO2019/129984.

This geared motor has a small footprint and is therefore suitable for controlling valves, for example hydraulic distributors used on motor vehicles. It also uses a centring pin that provides guidance, recentring of all moving parts and also performs the sliding bearing function for moving parts. Wear of the reduction gear is limited.

This geared motor uses 12 coils surrounding the rotor. It is desirable to reduce the number of coils, for example to six or even three. By reducing the number of coils, the coils then only face a part of the radially outer surface of the rotor. The inventors have found that during operation of the geared motor, repulsion forces from the coils were applied to the rotor substantially normal to the axis of rotation. Since these forces are only applied in one direction, the result could be an offset between the stator axis and the rotor rotation axis, and a risk of premature wear could then arise despite use of the single centring pin, reducing the reliability of the geared motor.

### PRESENTATION OF THE INVENTION

Consequently, one purpose of this invention to disclose a geared motor for which the risks of premature wear are even further reduced.

The purpose stated above is achieved by a geared motor comprising a stator, a rotor, a reduction gear and an output shaft. The stator comprises a housing into which the rotor fits. The housing comprising a lateral surface facing a lateral face of the rotor. The geared motor also comprises coils mounted on the stator so as to be facing a part of a lateral face of the rotor. Considering a plane orthogonal to the rotation axis of the rotor, the projection of the lateral surface in the plane is delimited partly by a first circle with a first radius, and partly by a second circle with a second radius, the second radius being greater than the first radius, and the coils are located in the zone of the lateral surface with the first radius. Thus, an angular zone is created for which the value of the air gap between the stator and the radial face of the rotor is greater than the value of the air gap in a zone of the stator comprising the coils. Thus the attraction force of the stator onto the rotor is higher in the small radius angular zone than the attraction force of the stator onto the rotor in the larger radius angular zone, and this has the effect of at least partly compensating for the repulsion forces exerted by the coils.

The rotor remains centred in the stator but its shape consists of a principal radius and a second slightly larger and coaxial radius.

Therefore, the offset of the rotor during operation is at least partially reduced or even eliminated. Therefore, the risks of premature wear of the geared motor are reduced.

Advantageously, the angular extension of the stator housing with the second radius is preferably similar to or equal to the angular extension of the rotor zone comprising the coils.

Very advantageously, the zone comprising the coils is diametrically opposite the zone with the largest air gap.

One subject-matter of this application is a geared motor comprising a brushless electric motor, a planetary reduction gear and an output shaft with a longitudinal axis, fixed in rotation to the planetary reduction gear, said electric motor comprising a stator, a rotor housed in a housing in the stator and surrounded by a lateral surface of the housing, said rotor being configured to rotate around a longitudinal axis, at least two coils attached to the stator in a portion of the lateral surface of the housing extending over an angle α3 such that they are facing a portion of an outer lateral surface of the rotor, wherein the stator and the rotor define at least one first zone with a first air gap and one second zone with a second air gap between them, the first air gap being less than the second air gap, the first zone comprising the coils, such that the attraction force exerted by the stator on the rotor is lower in the second zone than in the first zone.

Preferably, a section of said lateral surface of the housing in a plane orthogonal to the longitudinal axis comprises at least one first arc of a circle with radius R1 extending over an angle α1 and a second arc of a circle with radius R2 extending over an angle α2, R1<R2, and the part of the lateral surface of the housing containing the coils being contained in the part of the lateral surface of the housing having the first arc of a circle.

For example, R2−R1 is between 0.2 mm and 0.5 mm.

Advantageously, the part of the lateral wall of the housing delimited by the second arc of a circle is diametrically opposite the part of the lateral surface of the housing containing the coils.

Preferably, the angle α2 of the second arc of a circle is equal to the angle α3 of the part of the lateral surface of the housing containing the coils.

The geared motor can comprise three coils or a multiple of three coils.

For example, the stator is mounted on a circuit board to which the coils are connected.

Advantageously, the reduction gear is at least partially housed in the rotor.

According to another characteristic, the geared motor comprises a single shaft forming the rotation axis of the rotor and the spindle of the planetary reduction gear.

Another subject-matter of this application is a rotating fluidic device comprising a valve body with at least one fluid outlet orifice, a core capable of authorising or interrupting fluid flow through the outlet orifice and a geared motor according to the invention activating the core.

### BRIEF DESCRIPTION OF THE DRAWINGS

This invention will be better understood after reading the following description and the appended drawings on which:

FIG. 1 is a longitudinal section view of an example of a geared motor according to the invention used to activate a hydraulic distributor.

FIG. 2 is a top view of an example of a stator that can be used in the geared motor in FIG. 1.

FIG. 3 is a top view of the stator shown in FIG. 2, equipped with coils.

FIG. 4 is a top view showing the stator in FIG. 2, the coils covered by an insert moulding and a rotor.

FIG. 5 is a exploded view of the stator with its circuit board and the box inside which it is fixed.

FIG. 6 is a perspective view of an example of a lug for connection of the coils to the circuit board.

### DETAILED PRESENTATION OF PARTICULAR EMBODIMENTS

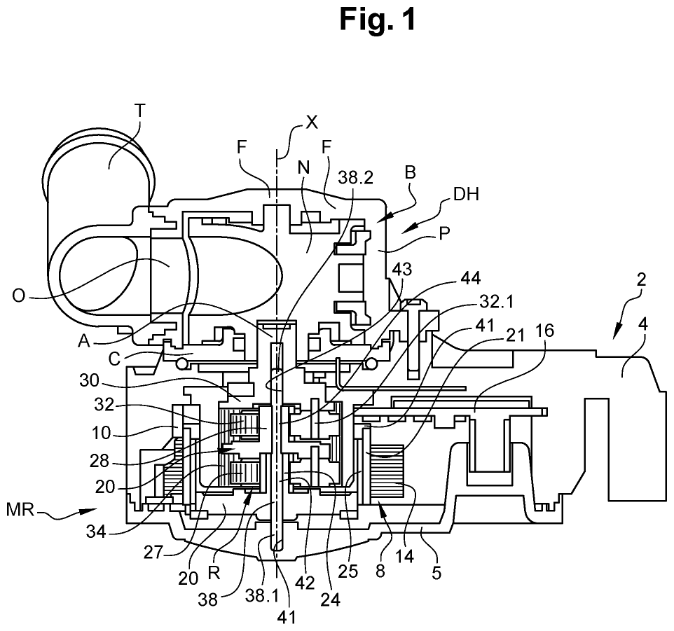

FIG. 1 is a longitudinal sectional view of an example of a hydraulic distributor DH driven by an geared motor MR according to the invention.

The distributor DH consists of a valve body B that is essentially in the shape of a cylinder of revolution about an X axis, and a core N mounted in the valve body B and able to rotate inside the valve body B.

In the example shown, valve body B comprises a bottom F and a single-piece cylindrical lateral wall P, and a valve cover C to close the valve body. For example, the valve cover C is fixed to the valve body B by welding, for example by ultrasonic welding.

The valve body B comprises a supply orifice (not visible) formed in lateral wall P and prolonged by a conduit for connection to a source of liquid, and at least 2 outlet orifices O also formed in the lateral wall P, each being prolonged by a conduit T intended to carry the liquid to a given zone, for example a zone to be cooled. The valve body B defines a hydraulic chamber.

The inlet and outlet orifices are distributed on the wall around the X-axis

The core N is mounted in the hydraulic chamber and is engaged with the output shaft A of the geared motor A.

The geared motor extends along a longitudinal axis X. It comprises a casing 2 inside which the electric motor M and the planetary reduction gear R are housed. The casing 2 protects the motor and the reduction gear from the external environment. One longitudinal end of output shaft A on which the core is engaged protrudes from the casing 2 through an opening 3.

Throughout the remainder of the description, the longitudinal end of the geared motor comprising the output shaft A will be designated as the “downstream end”, the other longitudinal end of the geared motor will be designated as the “upstream end”. The orientation of the different components of the geared motor relative to these ends may be denoted by the term “upstream” or “downstream”.

The casing 2 comprises a box 4 and a cover 5 that closes the box.

The electric motor is a brushless motor, and comprises a stator 8, a rotor 10 arranged in the stator 8 and an electronic board 16.

The stator 8 will be described in detail below.

FIG. 1 shows a first circuit board 16 to which the pins of the coils are connected and that is used to control the rotor. For example, the coils are electrically and mechanically connected to the circuit board 16 by lugs that are electrically connected to the coil by mechanical tightening.

The rotor 10 is mounted inside the stator and is intended to rotate inside the stator around the X axis. For example, the rotor 10 comprises a multi-pole magnet 21 forming the outer surface of the rotor and facing the coils.

The rotor 10 comprises a bottom forming a hub 20 comprising a gear 24 forming a first sun gear of the reduction gear R, on a downstream face opposite the face oriented towards the box. Therefore, the first sun gear 24 is driven in rotation directly by the hub 20.

The reduction gear also comprises a first planet carrier plate 26 and three first planet gears 27 mounted free to rotate on an upstream face of the planet carrier plate 26 around axes parallel to the X axis. The first planet gears 27 mesh with the first sun gear 24. A second sun gear 28 is fixed in rotation to the first planet carrier plate 26 and is positioned on the X axis on a downstream face of the first planet carrier plate 26, opposite the upstream face carrying the first planet gears 27.

The reduction gear comprises a second planet carrier plate 30 and three second planet gears 32 mounted free to rotate on an upstream face of the second planet carrier plate 30 around spindles 32.1 parallel to the X axis. The second sun gear 28 meshes with the second planet gears 32.

Advantageously, the planet gears 27 and 32 are identical, making the geared motor easier to manufacture.

The output shaft A of the geared motor is fixed in rotation to the second planet carrier plate 30 and projects from a downstream face of the second planet-carrier plate 30 opposite the upstream face carrying the second planet gears 32.

The output shaft A can be guided in rotation by the contour of the opening 3 formed in the cover.

The reduction gear also has an outer ring gear 34 on the X-axis, positioned inside the rotor 10 and outside the first 27 and second 32 planet gears, such that planet gears 27 and 32 engage with the ring gear 34. Therefore, all components of the reduction gear are positioned inside the ring gear 34. The ring gear 34 is fixed relative to the casing 2.

Very advantageously, the ring gear 34 is inserted inside the box 4, for example by casting. Alternatively, the ring gear 34 is fixed onto the box 4 by welding, bonding, screws, etc.

Very advantageously, a single centring pin 38 passes through the reduction gear R and the motor M and centres the various components of the reduction gear and the rotor 10 relative to the stator 8. The yoke 25 has a central passage passing through the first sun gear and through which the centring pin 38 passes. The air gap between the rotor 10 and the stator 8 is thus fixed without using a bearing. Elimination of the bearings contributes to extending the service life of the geared motor. In addition, manufacturing of the geared motor is simplified, and its mass is reduced.

The centring pin 38 is retained axially and transversely in the geared motor. To achieve this, the inner bottom of the cover 5 comprises a housing 41 into which a longitudinal end 38.1 of the pin 38 fits, and the second planet-carrier plate carrying the output shaft 30 also comprises a housing 43 between the second planet gears on its upstream face into which the other end 38.2 of the pin 38 fits. Since the second planet-carrier plate 30 is guided by the contour of the opening in the cover 5 through the output shaft A, the other end of the centring pin 38 is also held axially and transversely. The pin 38 is installed fixed in the cover 5, for example the end 38.1 is tight fitted in the housing 41 of the cover 5.

Furthermore, the first sun gear 24 and the second sun gear 28 comprise axial passages 42, 44 respectively in their centres, for the passage of the centring pin 38. The diameters of housings 40, 41 and housings 42, 44 are adjusted to the diameter of the pin 38, in order to ensure transverse retention of the centring pin 38 and a good rotational guide for the various components of the reduction gear.

The pin 38 provides guidance, recentring of all moving parts and also performs the sliding bearing function for moving parts.

The centring pin 38 is advantageously made of metal, for example steel, advantageously stainless steel to have sufficient stiffness. The diameter of the shaft can be fixed precisely by a grinding operation. Advantageously the pin 38 is made with high precision, for example by machining. The maximum tolerances on its diameter and its cylindricity are advantageously 20 μm and 5 μm respectively.

Clearances between the pin 38 that is fixed in the casing and the moving elements are advantageously between 20 μm and 60 μm.

The box and the cover are arranged such that the housings 40 and 41 ensure coaxiality between the centring pin 38 and the ring gear 34.

Use of the fixed centring pin and the positioning accuracy, that can be obtained when making the box and the cover that incorporates the ring gear 34 and during their assembly, very advantageously make it possible to avoid the use of a ball bearing between the centring shaft and the elements moving in rotation around it.

Use of this centring pin 38 helps to limit wear of the reduction gear. It also facilitates assembly. In the case of reduction gear elements made of plastic, It also makes it possible to provide sufficient clearance between the elements so that they mesh correctly.

Advantageously, the spindles of the planet gears on the planet carrier plates are made of steel, for example stainless steel, to further improve guidance and avoid wear of the planetary reduction gear teeth.

In addition, the use of a single pin can significantly reduce losses because the elements of the reduction gear free to move in rotation rotate around this small diameter pin.

The reduction gear may comprise a sensor of the angular position of the output shaft A.

The stator 8 will now be described in detail.

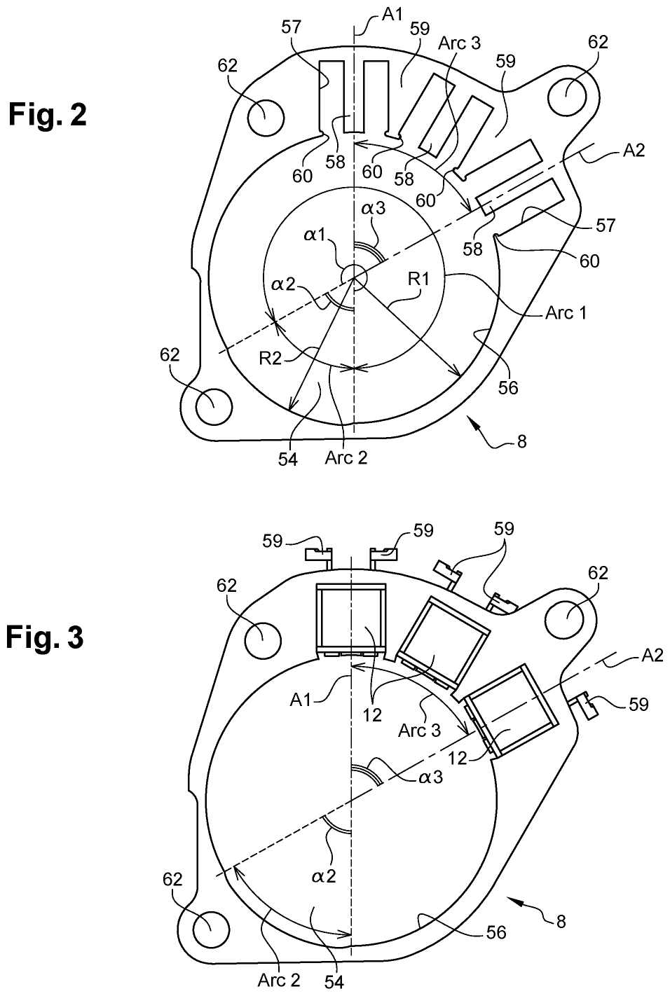

In FIG. 2, the stator 8 is shown alone and FIG. 3 shows the stator 8 fitted with coils 12.

For example, the stator 8 is composed of a stack of magnetic steel plates, for example made of M270-35A steel. Other steels such as M235-35A, M250-35A, and M330-35A can also be used, non-limitatively.

For example, the stator is composed of 28 plates, each 0.35 mm thick. It has a total thickness of 9.8 mm.

The stator comprises a housing 54 designed to house the rotor 10; the housing 54 passes through the entire thickness of the stator 8.

The housing 54 has an external lateral surface 56, part of which is occupied by the coils 12, this part is referred to as the “winding part”. The winding part is delimited angularly by two end edges 57 and comprises arms 58, in the example three arms 58, around each of which is assembled a support on which electrical conducting wire is wound so as to form a coil 12.

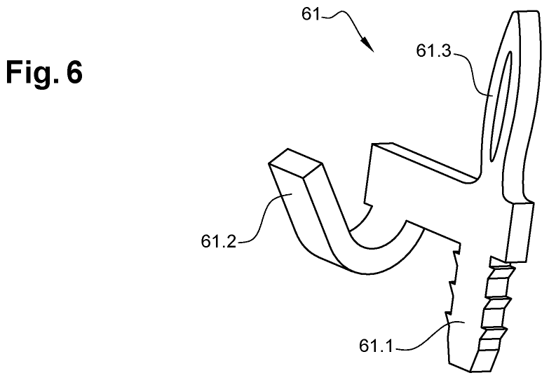

For example, each coil comprises a plastic body called a field frame, two connection lugs or plugs, and a wire wound on the body, and is connected at its two ends to the two lugs that are intended to be connected to the circuit board. The body of each coil is mounted on an arm 58. Advantageously, each lug 61 (FIG. 6) comprises an element 61.1 that is fastened to the field frame, for example it has teeth on its lateral sides so as to look like a sort of harpoon; the attachment element is inserted into the field frame. The lug also comprises a connection element 61.2 at one end of the wire, for example it is an element comprising two blades forming a V that are brought together to trap the end of the wire, that is then advantageously soldered. The lug also comprises a mounting and connection element 61.3 to the circuit board, for example the mounting and connection element 61.3 is force fitted into a housing on the circuit board. The lug is made of electrically conductive material.

The winding part also comprises two radial elements 59, each extending between two coils. The winding part also advantageously comprises means to retain the coils in the radial direction. In the example shown, the free ends of the radial elements 59 and the end edges 57 comprise teeth (60), that retain the coils 12 in the radial direction by click fitting. In this example, two teeth 60 are used for each coil. In the example shown, the winding part is defined by the angle between the spindles of the outermost coils, i.e. substantially the angle between the arms 58 on which the coils 12 are inserted.

The arms 58, the radial elements 59 and the teeth 60 are cut like the housing, for example by cold heading.

In the example shown and preferably, the electric motor is a three-phase motor comprising a number of coils 12 equal to a multiple of three. Nevertheless, a two-phase motor, and more generally a poly-phase motor, is not outside the scope of this invention.

In FIG. 3, the coils 12 formed around the arms 58 and the connection plugs 61 for the power supply to the coils can be seen, these plugs are connected to the circuit board 16.

The cross-section of the lateral surface of the housing in a plane orthogonal to the rotation axis of the rotor 8 has a first arc of a circle Arc1 with angle α1 and radius R1 and a second arc of a circle Arc2 with angle α2 and radius R2, wherein R2>R1.

The angle between the axes A1 and A2 of the outer coils 12 is designated α3. The part of the lateral surface of the housing delimited by the first arc of a circle ARC1 comprises the winding part.

The winding part extends over an angle α3<α1.

The difference in radius R2−R1 is not a result of manufacturing imprecisions. For example, the difference R2−R1 is equal to 0.25 mm for an imprecision of 0.03 mm. Preferably, 0.2 mm<R2−R1<0.5 mm. For example, R2−R1=0.25 mm, R2=19.25 mm, and R Rotor=18.5 mm.

For example, in the case of a three-coil stator, α1=300° and α2=60°.

For example, the axes of two consecutive coils are arranged at 30° relative to each other. In the case of a 6-coil stator, α2=120° and α1=180°.

The first arc of a circle Arc1 is connected to the second arc of a circle Arc2, for example by straight line portions inclined relative to the radial direction of the stator.

The rotor 10 is housed in the housing 54 of the stator 8, with part of the stator magnets facing the coils 12.

The value of the air gap between the radially outer surface of the rotor 8 and the lateral surface 56 of the housing 54 varies because of the arcs of a circle with different radii. In the example shown, the air gap substantially has two values: a first value E1 between the radially outer wall of the rotor 10 and the part of the lateral surface 56 of the housing 54 delimited by the first arc of a circle Arc1, and a second value E2 between the radially outer wall of the rotor 8 and the part of the lateral surface 56 of the housing 54 delimited by the second arc of a circle Arc2. The first air gap value E1 is less than the second air gap value E2. For example 0.2 mm<E1<0.5 mm, for example equal to 0.5 mm, and 0.75 mm<E2<1 mm, for example equal to 0.75 mm. Preferably, E1 is chosen to be as low as possible.

Thus, since the attraction force exerted by the stator 8 on the rotor 10 is proportional to the distance between them, this attraction force varies as a function of the contour of the lateral surface 56 of the housing 54. The attraction force is greater when the air gap is smaller, so it is greater for the first air gap value, i.e. along the arc of a circle Arc3, than for the second air gap value, i.e. along the arc of a circle Arc2.

The stator also comprises holes 62 on the box B through which screws 63 pass that secure the stator to the box 4.

On FIG. 5, a part of the geared motor can be seen from above, showing the stator, the plastic insert moulded coils 64, the circuit board 16 to which the coils 12, the box 4 and the ring gear 34 of the reduction gear are connected.

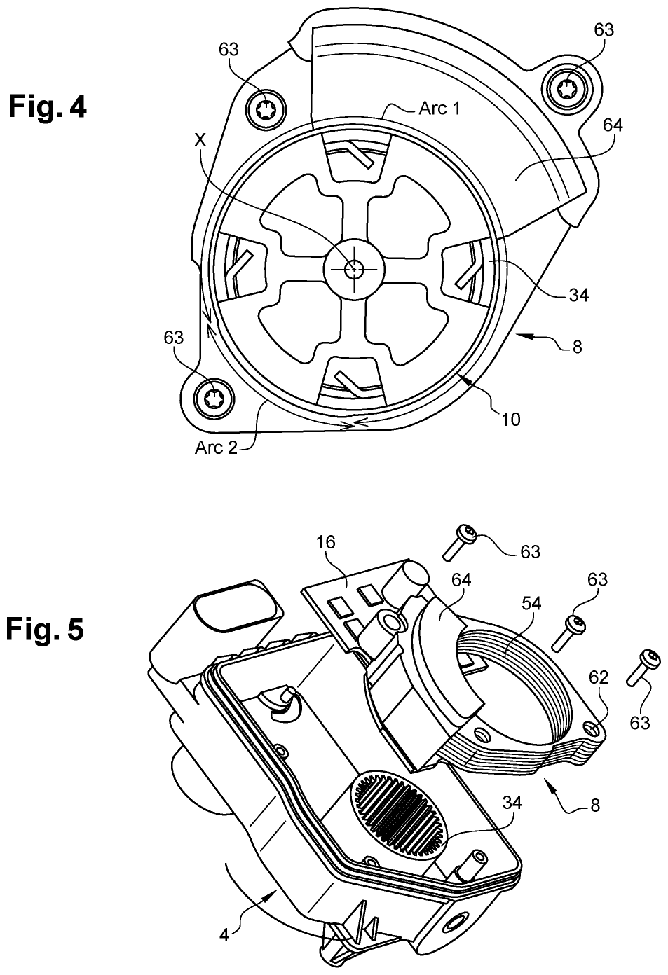

FIG. 5 is an exploded view of the part of the geared motor in FIG. 4.

Operation of the electric motor is as follows:

The coils 12 are supplied with out-of-phase electrical current, when a coil is energised, a repulsive force is exerted between the coil 12 and the part of the magnet facing it carried by the rotor, which tends to offset the rotor 10 from its rotation axis.

An attraction force is exerted continuously between the stator 8 and the rotor 10. The invention increases the magnitude of the attraction force of the stator 8 to the rotor 10 at the stator portion comprising coils 12, in comparison with the stator portion 8 without coils, this at least partly compensates for the repulsive force between the coils 12 and the rotor 10, thus at least partly reducing the offset of the rotor. As a result, the risks of friction between the rotor 10 and the stator 8 are reduced together with, for example, the risk of damage to the reduction gear due to this offset.

Preferably, the angles α2 and α3 are equal or substantially equal, so that the value of the length of the second arc of a circle Arc2 that is equal to 2πR2×α2/180 is very similar to the value of the length of the arc of a circle of the winding part Arc3, that is equal to 2πR1×α3/180, for α2 and α3 in degrees, for example the length of Arc2 is equal to 40.3 mm, and the length of Arc2 is equal to 39.8 mm.

Thus, the length of the zone over which the attraction force between the rotor 10 and the stator 8 is reduced is substantially equal to the length of the zone over which coils 12 exert their repulsion forces on the rotor 10.

Preferably, the winding part α3 is diametrically opposite the part of the surface bounded by the second arc of a circle Arc2; as shown in FIG. 3. Thus, the repulsion forces exerted by the coils on the rotor are exerted on a zone diametrically opposite to the zone with a reduced attraction force. This further reduces the offset of the rotor.

The external shape of the stator is not limitative, it is chosen as a function of the engine environment and manufacturing possibilities.

In the description, the geared motor is used for the control of a hydraulic distributor, but it will be understood that it can be used to operate any other device.

1. Geared motor comprising a brushless electric motor, a planetary reduction gear and an output shaft with a longitudinal axis, fixed in rotation to the planetary reduction gear, said electric motor comprising a stator, a rotor housed in a housing in the stator and surrounded by a lateral surface of the housing, said rotor being configured to rotate around the longitudinal axis, at least two coils attached to the stator in a portion of the lateral surface of the housing extending over an angle α3 such that they are facing a portion of an outer lateral surface of the rotor, wherein the stator and the rotor define at least one first zone with a first air gap and one second zone with a second air gap between them, the first air gap being less than the second air gap, the first zone comprising the coils, such that the attraction force exerted by the stator on the rotor is lower in the second zone than in the first zone.

2. Geared motor according to claim 1, wherein a section of said lateral surface of the housing in a plane orthogonal to the longitudinal axis comprises at least one first arc of a circle with radius R1 extending over an angle α1 and a second arc of a circle with radius R2 extending over an angle α, R1<R2, and the part of the lateral surface of the housing containing the coils being contained in the part of the lateral surface of the housing having the first arc of a circle.

3. Geared motor according to claim 1, wherein R2−R1 is between 0.2 mm and 0.5 mm.

4. Geared motor according to claim 1, wherein the part of the lateral wall of the housing delimited by the second arc of a circle is diametrically opposite the part of the lateral surface of the housing containing the coils.

5. Geared motor according to claim 1, wherein the angle α2 of the second arc of a circle is equal to the angle α3 of the part of the lateral surface of the housing containing the coils.

6. Geared motor according to claim 1, comprising three coils or a multiple of three coils.

7. Geared motor according to claim 1, wherein the stator is mounted on a circuit board to which the coils are connected.

8. Geared motor according to claim 1, wherein the reduction gear is at least partially housed in the rotor.

9. Geared motor according to claim 1, comprising a single shaft forming the rotation axis of the rotor and the spindle of the planetary reduction gear.

10. Rotating fluidic device comprising a valve body with at least one fluid outlet orifice, a core capable of authorising or interrupting fluid flow through the outlet orifice and a geared motor according to claim 1 activating the core.
